(19) United States
(12) Patent Application Publication
(10) Pub. No.: US 2009/0283646 A1
(43) Pub. Date: Nov. 19, 2009

(54) SUPPORT APPARATUS

(75) Inventor: Hiroshi Sugahara, Shiga (JP)

Correspondence Address: Cheng Law Group, PLLC, 1100 17th Street, N.W., Suite 503, Washington, DC, 20036, US

(73) Assignee: SEKISUI CHEMICAL CO., LTD., OSAKA-SHI OSAKA (JP)

(21) Appl. No.: 12/063,218

(22) PCT Filed: Jul. 31, 2006
(86) PCT No.: PCT/JP2006/315148

§ 371 Date: Feb. 7, 2008

(30) Foreign Application Priority Data
Aug. 12, 2005 (JP) 2005-234096

(51) Int. Cl. F16L 3/08

(52) U.S. Cl. 248/73

(57) ABSTRACT

A support apparatus 1 that supports a lining pipe L when packing back-filling material between the inner surface of an existing pipe K and the outer surface of the lining pipe L, the lining pipe L having been newly installed within the existing pipe K, the support apparatus comprising a frame 2, and a support member 3 and a movement means 4 provided in the frame 2. The support member 3 includes support portions 32, 34, and 35 that can be freely moved between a supporting position in which the support portions 32, 34, and 35 support the lining pipe L and a retracted position in which the support portions 32, 34, and 35 are retracted from the lining pipe L, and the movement means 4 makes contact with and is capable of traveling on the inner surface of the lining pipe L when the support portions 32, 34, and 35 are in the retracted position.

### TECHNICAL FIELD

The present invention relates to a support apparatus used when newly installing a lining pipe within an existing pipe.

### BACKGROUND ART

It is necessary to repair existing pipes, such as pipes for clean water/waste water that are laid underground, when such pipes deteriorate. A lining construction technique for restoring existing pipes has been proposed in which, when repairing existing pipes that have deteriorated, a lining pipe is newly installed within the existing pipe, and back-filling material is packed in the space between the inner surface of the existing pipe and the outer surface of the lining pipe (see, for example, Patent Document 1).

With such a lining construction technique, when back-filling material is packed in the space between the inner surface of the existing pipe and the outer surface of the lining pipe, there are situations where the lining pipe experiences deformation due to the pressure of the packed back-filling material, or buoyancy caused by a liquid back-filling material causes the lining pipe to lift. Support apparatuses are used to prevent the lining pipe from experiencing this kind of deformation or lifting.

Such support apparatuses are made up of a frame and a support member provided on the frame, and are brought into the lining pipe prior to the packing of the back-filling material; the lining pipe is supported by the support member from within (see, for example, Patent Documents 2 and 3).

### [Patent Document 1] JP H3-48392B

### [Patent Document 2] Japanese Patent No. 3377701

### [Patent Document 3] Japanese Patent No. 3377702

### DISCLOSURE OF THE INVENTION

### Problem to be Solved by the Invention

When restoring an existing pipe, the pipe is divided into several sections, which are restored in sequence; that is, when the restoration of a section is complete, restoration of the next section is commenced. However, the support apparatuses mentioned above have a problem in that they require assembly, and thus when the restoration of a section is complete, it is necessary to break down the support apparatus into its frame and support member, transport these to the next section, and then reassemble the support apparatus from the frame and the support member in the next section, which complicates operations, reduces operational efficiency, and lengthens the construction period.

Having been conceived in light of this problem, it is an object of the present invention to provide a support apparatus that can be moved to the next section of a pipe, when restoring an existing pipe using a lining pipe, without requiring assembly/disassembly.

### Means to Solve the Problems

A characteristic of the present invention is a support apparatus that supports a lining pipe when packing back-filling material between the inner surface of an existing pipe and the outer surface of the lining pipe, the lining pipe having been newly installed within the existing pipe, the support apparatus comprising: a frame; and a support member and a movement means provided in the frame, wherein the support member includes support portions that can be freely moved between a supporting position in which the support portions make contact with and support the inner surface of the lining pipe and a retracted position in which the support portions are retracted from the inner surface of the lining pipe; and the movement means, which is anchored to the frame, rests upon and is capable of traveling on the inner surface of the lining pipe when the support portions are in the retracted position.

According to the present invention, when the support portions are in the retracted position, the movement means rest upon the inner surface of the lining pipe and are capable of travel, and thus the support apparatus can be moved to the next section.

As a result, the support apparatus does not need to be disassembled and reassembled in each section where work is performed, which shortens the operational time and reduces costs.

Another characteristic of the present invention is a support apparatus that supports a lining pipe when packing back-filling material between the inner surface of an existing pipe and the outer surface of the lining pipe, the lining pipe having been newly installed within the existing pipe, the support apparatus comprising: a frame; and a support member and movement means provided in the frame, wherein the support member includes support portions that can be freely moved between a supporting position in which the support portions make contact with and support the inner surface of the lining pipe and a retracted position in which the support portions are retracted from the inner surface of the lining pipe; and the movement means can be lifted and dropped freely between a traveling position in which the movement means rests upon the inner surface of the lining pipe and a retracted position in which the movement means is retracted from the inner surface of the lining pipe.

According to the present invention, retracting the support portions and causing the movement means to rest upon the inner surface of the lining pipe makes it possible to move the support apparatus to the next section using the movement means.

As a result, the support apparatus does not need to be disassembled and reassembled in each section where work is performed, which shortens the operational time and reduces costs.

In the present invention, the support portions can be provided with a pressure plate that can be freely attached/detached, and an injection nozzle attachment member, inserted into an injection hole formed in the lining pipe, can be anchored by the pressure plate. Accordingly, when the support portions are in the supporting position and support the lining pipe, an injection nozzle attachment member provided in the injection hole of the lining pipe can be anchored by providing the support portion with the pressure plate. For this reason, operations for joining the injection nozzle attachment member with the support portion through, for example, welding, are unnecessary, which makes it possible to improve operational efficiency.

In this case, it is preferable to provide a check valve, which prevents backflow of the back-filling material, in the injection nozzle attachment member. Through this, the back-filling material will not flow back through the injection nozzle attachment member even when the packing of the back-filling material is completed and the injection nozzle is removed from the injection nozzle attachment member.

In the present invention, when the frame is configured of a frame lower portion, a frame upper portion connected to the frame lower portion via a support post that is freely liftable and droppable, and frame side portions connected to the left and right ends of the frame upper portion so as to be freely rotatable and connected to the support post via a freely extendable and retractable extension arm; and the support portions are configured of plural lower support portions connected to the frame lower portion, plural upper support portions connected to the frame upper portion, and plural side support portions connected to the left and right frame side portions, respectively, the frame upper portion is lifted and dropped relative to the frame lower portion via the support post, and the left and right frame side portions connected to the frame upper portion lift and drop in accordance therewith. For this reason, when supporting or retracting from the cross-sectional horseshoe-shaped lining pipe, the left and right frame side portions make contact with or retract from the inner surface of the lining pipe in accordance with the lifting or dropping of the frame upper portion. Therefore, it is possible to reduce, to the greatest extent possible, the amount of movement of the left and right frame side portions in the left and right directions caused by the manipulation of the extension arms, and to move the left and right frame side portions into their supporting positions or retracted positions in a short amount of time.

In the present invention, when the frame is configured of plural frame lower portions connected at intervals in the front and rear directions by frame connectors, plural frame upper portions connected respectively to the frame lower portions via support posts that are freely liftable and droppable, and plural left and right frame side portions, each of which is connected to the left and right ends of respective frame upper portions so as to be freely rotatable and connected to respective support posts via freely extendable and retractable extension arms; and the support portions are configured of plural lower support portions connected across the plural frame lower portions, plural upper support portions connected across the frame upper portions, and plural side support portions connected across the left and right frame side portions, the frame upper portions are lifted and dropped relative to the frame lower portions via the support posts, and the left and right frame side portions connected to the frame upper portions lift and drop in accordance therewith. For this reason, when supporting or retracting from the cross-sectional horseshoe-shaped lining pipe, the plural left and right frame side portions make contact with or retract from the inner surface of the lining pipe in accordance with the lifting or dropping of the frame upper portions. Therefore, it is possible to reduce, to the greatest extent possible, the amount of movement of the plural left and right frame side portions in the left and right directions caused by the manipulation of the extension arms, and to move the plural left and right frame side portions into their supporting positions or retracted positions in a short amount of time.

In the present invention, it is preferable for the lower support portions, the upper support portions, and the side support portions are formed so as to be of lengths corresponding to a curvature in the lining pipe, and to be connected to the frame lower portions, the frame upper portions, and the left and right frame side portions, respectively, that face the curvature, so as to be freely attachable and detachable. Through this, it is possible to select support portions of lengths corresponding to inner curved portions and outer curved portions of the lining pipe, and connect these support portions to the frames facing the inner curved portions and outer curved portions, which makes it possible to support the lining pipe even in the case where the lining pipe has curvatures. For example, when the lining pipe curves in the left or right directions when viewed from the top, left or right side support portions of a relatively shorter size may be connected to one of the left and right frame side portions opposite the inner curved portion, where the curvature radius of the lining pipe is smaller, relatively speaking, so as to correspond to the inner curved portion. Similarly, left or right side support portions of a relatively longer size may be connected to the other of the left and right frame side portions opposite the outer curved portion, where the curvature radius of the lining pipe is larger, relatively speaking, so as to correspond to the outer curved portion. The inner curved portion and outer curved portion of the lining pipe L may be supported in this manner.

In the present invention, when bearing members that make contact with and are capable of supporting the left and right frame side portions are provided on the left and right ends of the frame lower portions, the left and right frame side portions can be supported by the frame lower portion via the bearing members. For this reason, the frame lower portion, frame upper portion, and left and right frame side portions can be formed in a frame body, making it possible to obtain a frame structure with high rigidity against external pressure. In particular, when plural frame lower portions are connected via frame connectors, the support portions are connected across the plural frame bodies, which greatly improves the rigidity and makes it possible to stand up to a great external force.

In the present invention, it is preferable for the lower support portions, upper support portions, and side support portions to be 0.5 m to 10 m in length, so that the support apparatus can be moved by human power. In other words, in an environment in which water is present, a power source that utilized electricity is dangerous due to the possibility of electric shock, and thus cannot be used, meaning that the support apparatus is required to be moved my human power. Here, the tractive force necessary to move the support apparatus can be determined based on the average tractive force of a single worker and the number of workers, and thus it is possible to obtain a support apparatus of a weight capable of being moved by human power as long as the support apparatus is provided with support portions up to a length of about 10 m.

### BRIEF DESCRIPTION OF DRAWINGS

FIG. 1 is a front view of an embodiment of a support apparatus according to the present invention.

FIG. 2 is a cross-sectional view of the support apparatus of FIG. 1 viewed along the A-A line.

FIG. 3 is a cross-sectional view of the support apparatus of FIG. 1 viewed along the B-B line.

FIG. 4 is a front view illustrating the support apparatus of FIG. 1 when a support portion is in a retracted position.

FIG. 5 is a cross-sectional view illustrating the relationship between a support portion, an injection nozzle attachment member, a sealant, and a pressure plate.

FIG. 6 is a front view illustrating a state in which the support apparatus of FIG. 1 has been brought into a lining pipe when a support portion is in the retracted position.

FIG. 7 is a front view illustrating the support apparatus of FIG. 1 in a state in which a lining pipe is supported by a support portion in a supporting position.

FIG. 8 is an enlarged cross-sectional view illustrating a state in which an injection nozzle attachment member is anchored to a lining pipe through a pressure plate.

FIG. 9 is a front view illustrating a state in which back-filling material has been packed while being supported by the support apparatus of FIG. 1.

FIG. 10 is a front view illustrating another embodiment of a support apparatus according to the present invention along with a lining pipe, back-filling material, and an existing pipe.

FIG. 11 is a cross-sectional view of the support apparatus of FIG. 10 viewed along the C-C line.

FIG. 12 is a front view illustrating a state in which the support apparatus of FIG. 10 has been brought into a lining pipe when a support portion is in the retracted position.

FIG. 13 is a front view of still another embodiment of a support apparatus according to the present invention.

FIG. 14 is a front view illustrating a state in which back-filling material has been packed while being supported by the support apparatus of FIG. 13.

FIG. 15 is a front view of yet another embodiment of a support apparatus according to the present invention.

FIG. 16 is a front view illustrating a state in which back-filling material has been packed while being supported by the support apparatus of FIG. 15.

### DESCRIPTION OF REFERENCE NUMERALS

1 support apparatus
2 frame
21 frame lower portion
22 frame side portion
23 frame upper portion
25 frame connector
28, 28A support post
29 extension arm
3 support member
31 connection bolt
32, 321 lower support portion
34, 341 side support portion
35, 351 upper support portion
4 movement means
41 running wheel
K existing pipe
L lining pipe
U back-filling material

### BEST MODE FOR CARRYING OUT THE INVENTION

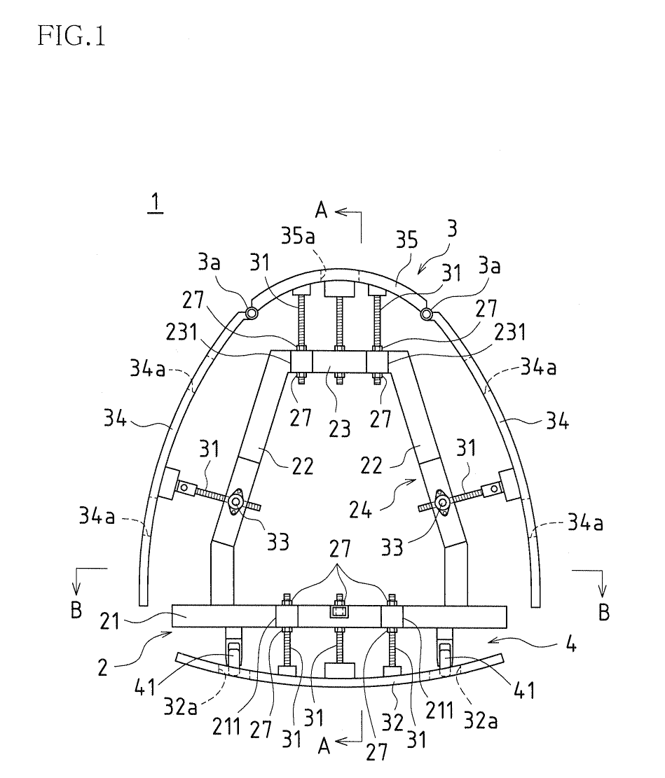

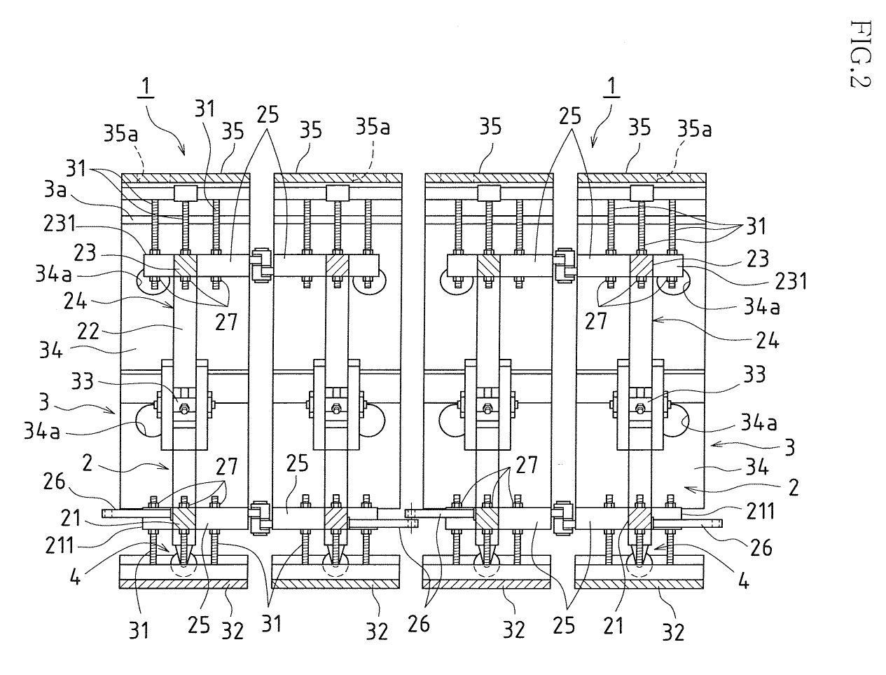

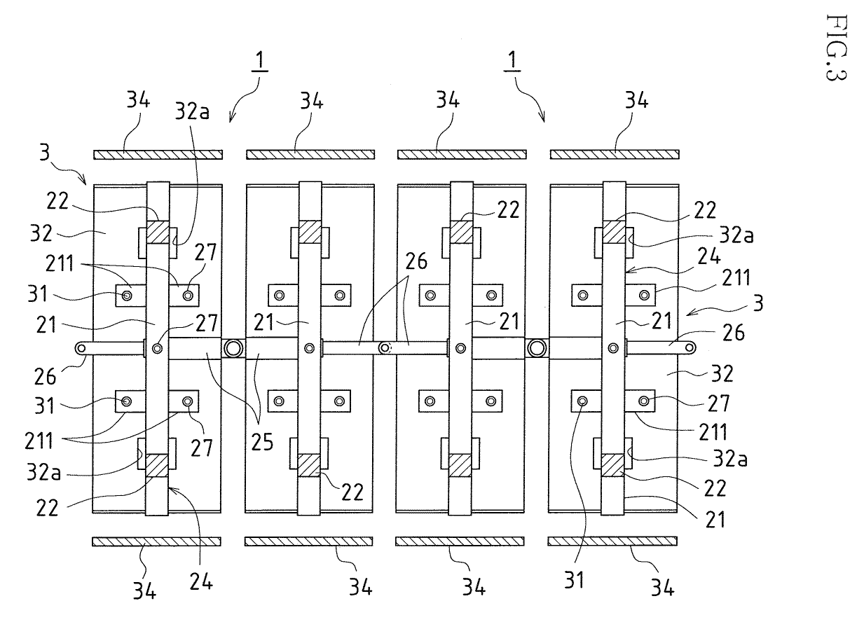

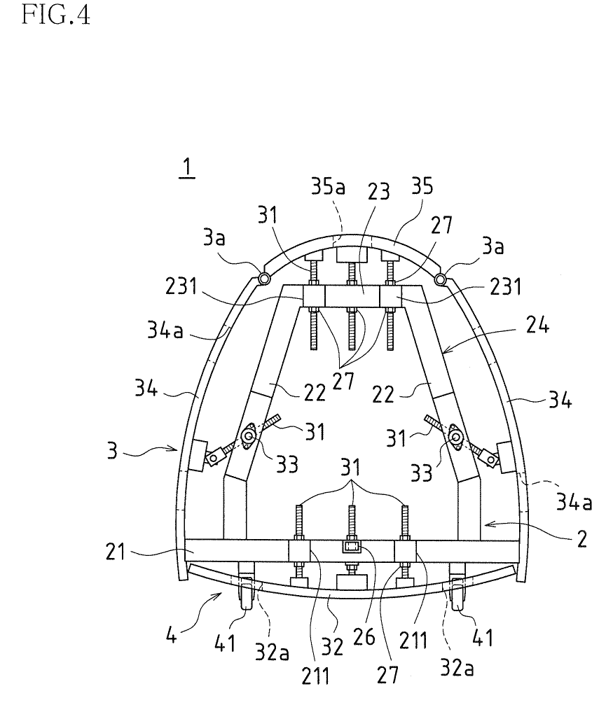

Hereinafter, embodiments of the present invention shall be described with reference to the drawings. FIGS. 1 through 4 illustrate an embodiment of a support apparatus 1 according to the present invention.

The support apparatus 1 includes a frame 2, a support member 3 provided on the frame 2, and a movement means 4.

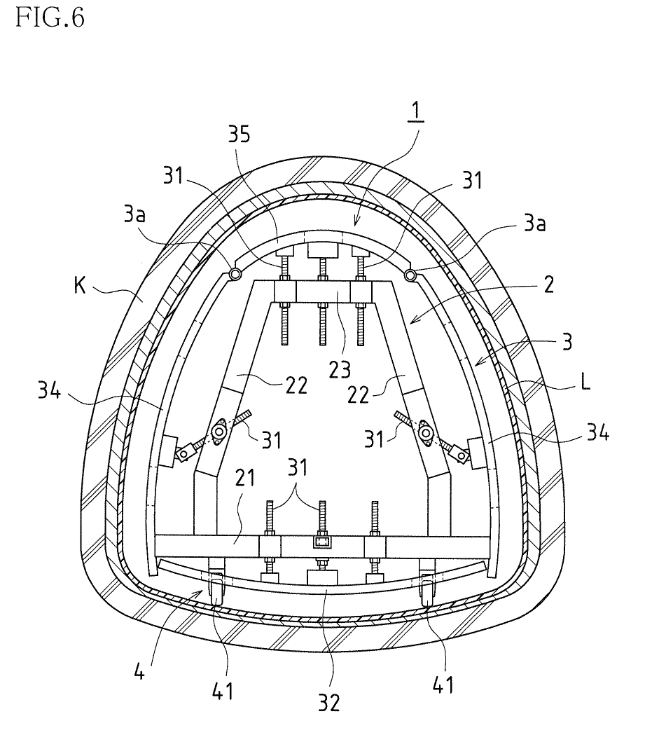

The frame 2 is configured of: front and back frame bodies 24, each of which includes a frame lower portion 21, left and right frame side portions 22, the bottom ends of which are welded solid to the left and right sides, respectively, of the frame lower portion 21, and an frame upper portion 23 welded solid across the respective top ends of the left and right frame side portions 22; and frame connectors 25 provided between the frame lower portions 21 and frame upper portions 23 of the front and back frame bodies 24. Each frame body 24 is formed in an almost trapezoidal shape so as to conform to a lining pipe L, which has a cross-sectional horseshoe shape (see FIG. 6). Lower frame supports 211 and upper frame supports 231 are welded solid to the left and right ends of the frame lower portion 21 and the left and right ends of the frame upper portion 23, respectively, of each frame body 24, and each extends in the front and rear directions.

A yawing bar 26 extending in the front direction is welded solid to the frame lower portion 21 of the front frame body 24, and another yawing bar 26 is welded solid to the frame lower portion 21 of the rear frame body 24. A connection hole, into which a connecting pin can be inserted, is formed at the tip of each yawing bar 26. Accordingly, plural support apparatuses 1 can be connected to one another by inserting connecting pins into the connection holes of the yawing bars 26 and 26 in the support apparatuses 1 and 1 to the front and rear. At this time, the yawing bars 26 and 26 are capable of rotating central to the vertical axis of the connecting pin, meaning that a support apparatus 1 in the rear can be rotated relative to a support apparatus 1 in the front so as to conform to curvatures in the lining pipe L.

Meanwhile, through-holes, through which connection bolts 31 for support members 3 (described later) can be passed, are formed in the middle on the right and left sides of the frame upper portion 23 and the frame lower portion 21, respectively, of each frame body 24, and nuts 27 into which the connection bolts 31 can be threaded are anchored opposed to one another on the top and bottom of the through-holes. Similarly, through-holes, through which connection bolts 31 for support members 3 can be passed, are also formed in the lower frame supports 211 extending in the front and rear directions on the respective left and right ends of the frame lower portion 21, and in the upper frame supports 231 extending in the front and rear directions on the respective left and right ends of the frame upper portion 23. Nuts 27 into which the connection bolts 31 can be threaded are anchored opposed to one another on the top and bottom of the through-holes.

The support member 3 is configured of: plural connection bolts 31 threaded into the respective nuts 27 provided in the frame lower portion 21 and lower frame support 211 of each frame body 24; a lower support portion 32 connected rotatably to these connection bolts 31; trunnions 33 having female screws and that are supported pivotally so as to be rotatable central to the horizontal axes of the respective frame side portions 22 on the left and right of each frame body 24; a connection bolt 31 threaded into each trunnion 33; left and right side support portions 34 connected rotatably to these connection bolts 31; plural connection bolts 31 threaded into the respective nuts 27 provided in the frame upper portion 23 and upper frame support 231 of each frame body 24; and an upper support portion 35 connected rotatably to these connection bolts 31. The lower support portion 32, left and right side support portions 34, and upper support portion 35 are formed in a shape corresponding to the shape of the inner surface of the newly-installed lining pipe L. Furthermore, each of the left and right ends of the upper support portion 35 are connected to the respective tops of the left and right side support portions 34 by hinges 3a, and are pivotally supported so as to be rotatable central to the horizontal axis of the hinges 3a. The left and right support portions 34 are pivotally supported so as to be rotatable central to the horizontal axis of their portions that connect to the connection bolts 31.

Accordingly, causing the connection bolts 31 to rotate relative to the respective nuts 27 can extend/retract the lower support portion 32 relative to the frame lower portion 21, and can cause the upper support portion 35 to extend/retract relative to the frame upper portion 23. Furthermore, causing the connection bolts 31 to rotate relative to the trunnions 33 can extend/retract the side support portions 34 relative to the frame side portions 22. Here, because the upper support portion 35 and left and right side support portions 34 are connected via the hinges 3a, the left and right support portions 34 rotate central to the pivotal support portion of the trunnions 33 in accordance with the extension/retraction of the upper support portion 35, and also rotate central to the horizontal axis of their portions that connect to the connection bolts 31, thus conforming in shape.

It should be noted that openings 32a in positions corresponding to the running wheels 41, which are the movement means 4 (described later), are formed in the lower support portion 32.

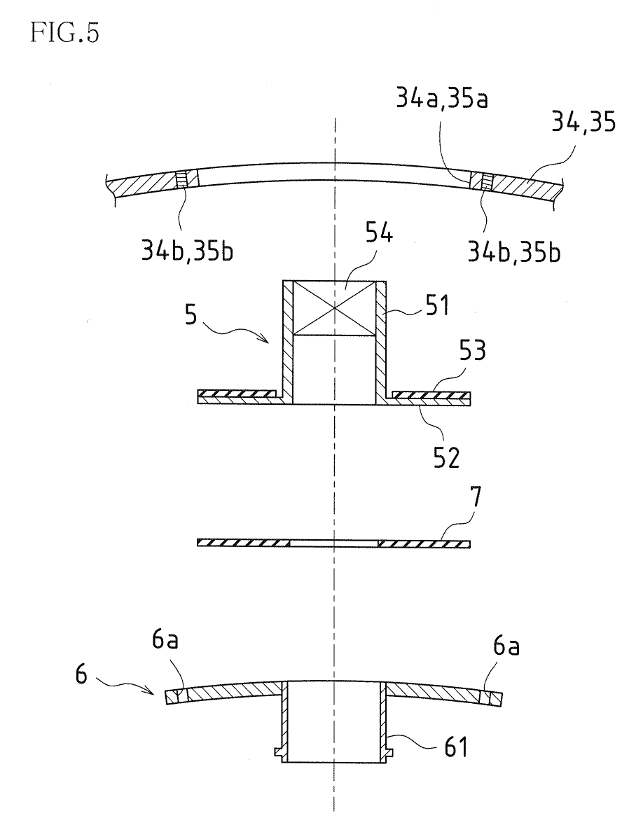

Furthermore, injection openings 34a and 35a for attaching an injection nozzle attachment member 5 (described later) are formed in the left and right side support portions 34 and the upper support portion 35, as are female screws 34b and 35b (see FIG. 5) for anchoring a pressure plate 6 (described later) to the periphery of the injection openings 34a and 35a.

The movement means 4 is running wheels 41 pivotally supported so as to be rotatable on brackets provided on the left and right ends of the frame lower portion 21 of each frame body 24.

Incidentally, because back-filling material U is to be packed in the space between an existing pipe K and a lining pipe L, an injection nozzle attachment member 5 is anchored, via a pressure plate 6, to the aforementioned injection openings 34a and 35a formed in the left and right side support portions 34 and the upper support portion 35.

To be more specific, as shown in FIG. 5, the injection nozzle attachment member 5 is configured of a pipe-shaped portion 51 and a flange 52 provided in the end thereof; a sealant 53 is provided on the external surface side of the flange 52, and a check valve 54 is provided in the pipe-shaped portion 51. Furthermore, the pressure plate 6 has attachment holes 6a that correspond to the female screws 34b and 35b formed in the periphery of the injection opening 34a of the left and right side support portions 34 and the injection opening 35a of the upper support portion 35. As shall be described later, the pressure plate 6 sandwiches the flange 52 of the injection nozzle attachment member 5 between itself and the lining pipe L, and can be tightened down into the left and right side support portions 34 and the upper support portion 35 through bolts b.

Also note that a pipe-shaped joint portion 61, capable of coupling with a back-filling material U injection nozzle (not shown), is provided in the pressure plate 6.

Hereinafter, operations of the support apparatus 1 configured in this manner shall be described.

First, a lining pipe L formed by, for example, winding band forms into a spiral form and coupling the ends of adjacent band forms to one another, is newly installed in an existing pipe K. After this, the support apparatus 1 is brought into the interior of the newly-installed lining pipe L through a shaft (not shown) and is transported to the section where packing of the back-filling material U is to be commenced. At this time, as shown in FIG. 6, the support portions 32, 34, and 35 of the support apparatus 1 are in a retracted position, distanced from the inner surface of the lining pipe L, and the running wheels 41 are resting upon the lining pipe L. Therefore, the support apparatus 1 can be transported along the lining pipe L without interfering therewith.

Next, connection bolts 31 are rotated relative to the frame lower portion 21, causing the lower support portion 32 to drop down and push against the inner surface of the lining pipe L. Furthermore, the connection bolts 31 are rotated, causing the frame lower portion 21 to elevate, relatively speaking, causing the running wheels 41 to lift off of the inner surface of the lining pipe L. Similarly, connection bolts 31 are rotated relative to the frame upper portion 23, causing the upper support portion 35 to elevate and push against the inner surface of the lining pipe L. Here, the left and right side support portions 34 connected to the upper support portion 35 via the hinges 3a are also raised up in accordance with the elevation of the upper support portion 35. If upper support portion 35 is pushing against the inner surface of the lining pipe L, connection bolts 31 are rotated relative to the trunnions 33 provided in the frame side portions 22, extending the left and right side support portions 34 in the outer direction. At this time, the left and right side support portions 34 rotate central to the hinges 3a between the side support portions 34 and the upper support portion 35, thereby pushing against the inner surface of the lining pipe L.

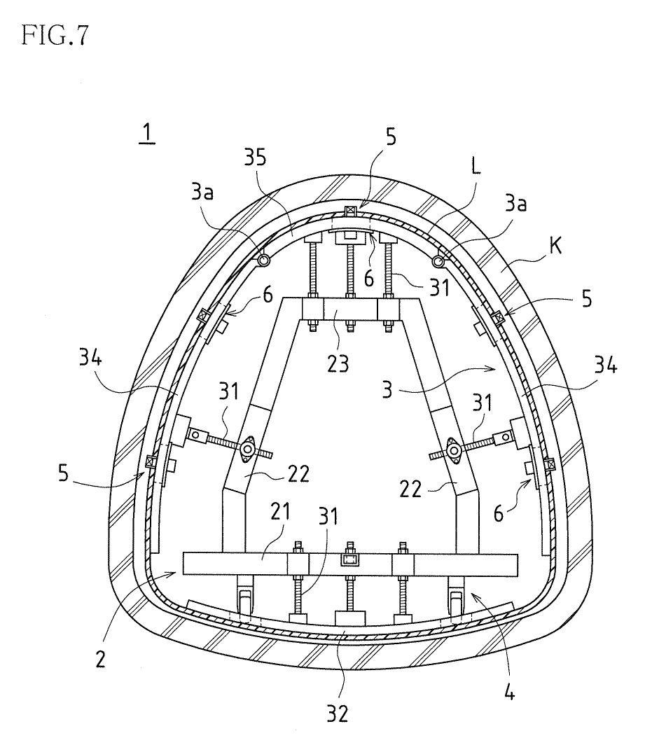

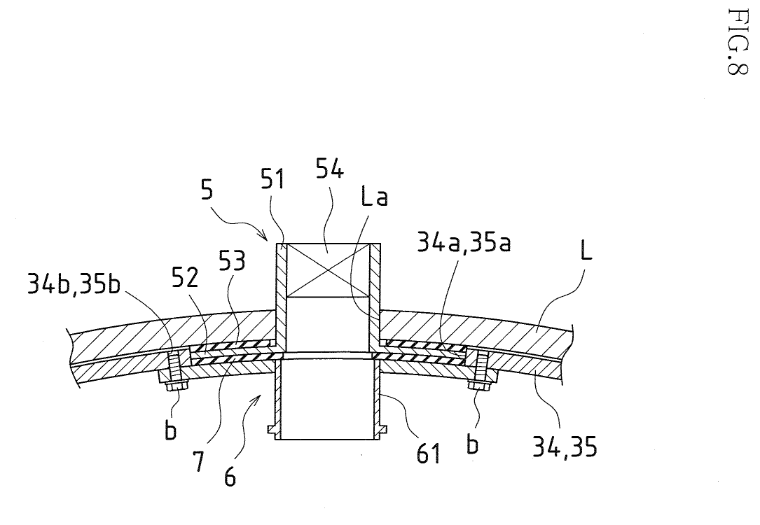

If the lower support portion 32, the side support portions 34, and the upper support portion 35 are each pushed against the inner surface of the lining pipe L, injection holes La, through which the pipe-shaped portion 51 of the injection nozzle attachment member 5 can pass, are formed in the lining pipe L, corresponding to the injection openings 34a in the left and right side support portions 34 and the injection opening 35a in the upper support portion 35. Then, the pipe-shaped portion 51 of the injection nozzle attachment member 5 is inserted into the injection holes La of the lining pipe L through the injection openings 34a and 35a of the left and right side support portions 34 and upper support portion 35, while pressure plates 6 are applied over sealant 7 on the left and right side support portions 34 and the upper support portion 35, sandwiching the flange 52 of the injection nozzle attachment member 5 between themselves and the lining pipe L. After this, bolts b are passed through the attachment holes 6a of the pressure plates 6, and are tightened down into the female screws 34b and 35b of the left and right side support portions 34 and the upper support portion 35, thereby preventing the injection nozzle attachment member 5 from dislodging and anchoring the pressure plate 6 (see FIGS. 7 and 8).

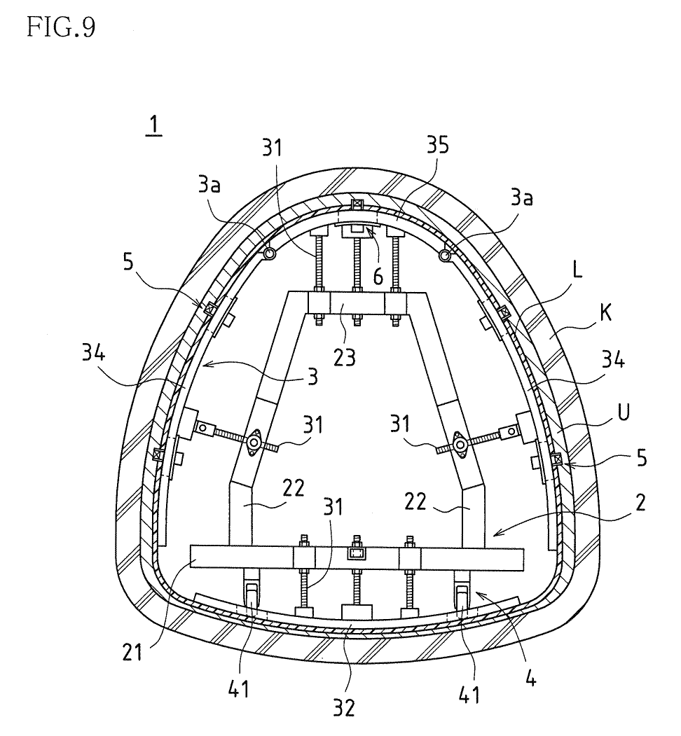

If the injection nozzle attachment member 5 has been anchored, an injection nozzle (not shown) is coupled with the joint portion 61 of the pressure plate 6, and if back-filling material U is then supplied, the back-filling material U is packed into the space created between the outer surface of the lining pipe L, which is supported by the support apparatus 1, and the inner surface of the existing pipe K (see FIG. 9). In this case, the check valve 54 provided in the injection nozzle attachment member 5 prevents the packed back-filling material U from experiencing backflow.

At this time, the packing pressure of the back-filling material U used in the lining pipe L can be supported by the frame lower portion 21, the left and right frame side portions 22, and the frame upper portion 23, of which the frame body 24 is configured, and to which are connected, via the respective connection bolts 31, the lower support portion 32, the left and right side support portions 34, and the upper support portion 35, which push against the inner surface of the lining pipe L. In other words, a high rigidity can be secured by the frame body 24, configured of the frame lower portion 21, the left and right frame side portions 22, and the frame upper portion 23, and accordingly, the packed pressure of the back-filling material U that acts on the support portions 32, 34, and 35 via the lining pipe L can be supported by this high rigidity.

Once the packing of the back-filling material U has finished, the bolts b are loosened and the pressure plate 6 and sealant 7 are removed in order from the side support portion 34 and the upper support portion 35; after this, a cap (not shown) is placed on the pipe-shaped portion 51 of the injection nozzle attachment member 5, closing off the opening of the pipe-shaped portion 51.

Meanwhile, once the back-filling material U has hardened to a constant hardness, each support portion is returned to its retracted position, and the support apparatus 1 is moved to the next section. To be more specific, in each support apparatus 1, connection bolts 31 are rotated relative to the trunnions 33 provided in the frame side portions 22, causing the side support portions 34 to rotate central to the hinges 3a connecting the upper support portion 35 thereto, bringing the side support portions 34 in toward the frame side portions 22. Through this, the side support portions 34 retract from the inner surface of the lining pipe L. Furthermore, connection bolts 31 are rotated relative to the frame upper portion 23, causing the upper support portion 35 to withdraw and retract from the inner surface of the lining pipe L; in accordance with the upper support portion 35 dropping, the left and right side support portions 34 connected thereto via the hinges 3a are also withdrawn. Next, connection bolts 31 are rotated relative to the frame lower portion 21, causing the lower support portion 32 to rise up. The rising of the lower support portion 32 causes the frame lower portion 21 to drop, relatively speaking, so that the running wheels 41 protrude from the openings 32a in the lower support portion 32 and rest upon the inner surface of the lining pipe L.

Here, as shown in FIG. 6, the lower support portion 32, side support portions 34, and upper support portion 35 of the support apparatus 1 retract from the inner surface of the lining pipe L, and because the running wheels 41 are resting upon the inner surface of the lining pipe L, the support apparatus 1 can be moved to the next section using the running wheels 41. Then, in the next section, the lower support portion 32, side support portions 34, and upper support portion 35 of each support apparatus 1 may be extended to their supporting positions so as to support the lining pipe L, the injection nozzle attachment member 5 may be attached, and the back-filling material U packed, in the manner described above.

In this case, the pipe-shaped portion 51 of the injection nozzle attachment member 5 is embedded in the back-filling material U, and only the flange 52 remains in the inner surface of the lining pipe L, making it possible to suppress the amount to which the injection nozzle attachment member 5 protrudes from the lining pipe L to the greatest possible extent. This can prevent interference with the side support portions 34, upper support portion 35, and so on when moving the support apparatus 1.

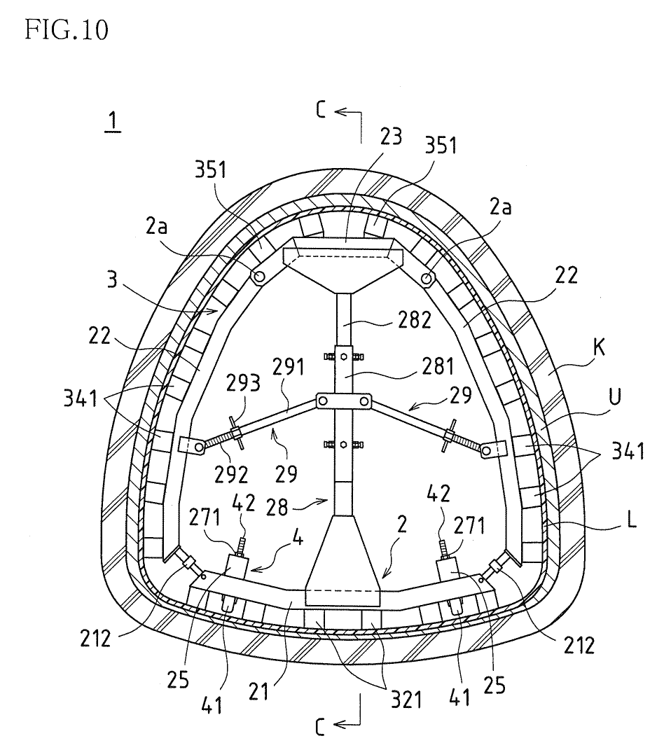

FIGS. 10 through 12 illustrate another embodiment of the support apparatus 1 according to the present invention.

The support apparatus 1 also includes a frame 2, a support member 3 provided on the frame 2, and a movement means 4.

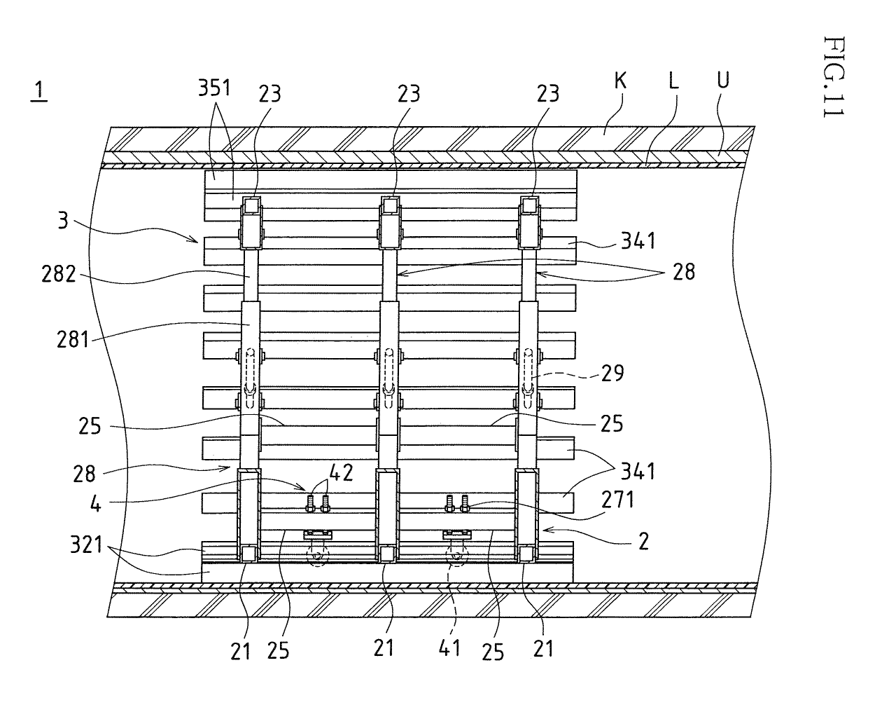

The frame 2 is configured of a frame lower portion 21; a support post 28, the lower end of which is welded solid to the middle of the frame lower portion 21; a frame upper portion 23 welded solid to the upper end of the support post 28; left and right frame side portions 22 connected rotatably to the left and right ends of the frame upper portion 23 via hinges 2a; and frame connectors 25 provided between the left and right ends of three frame lower portions 21 arranged at set intervals in the front and rear directions and between three support posts 28 (see FIG. 11). The frame lower portion 21, left and right frame side portions 22, and frame upper portion 23 are formed in a shape so as to substantially conform to a lining pipe L, which has a cross-sectional horseshoe shape. On both ends of the frame lower portion 21, a bearing member 212 having a turnbuckle is pivotally supported so as to be rotatable, the bearing member 212 being capable of supporting the left and right frame side portions 22.

Furthermore, the support post 28 is configured of a cylinder portion 281 anchored to the frame lower portion 21 and a piston portion 282 fitted into the cylinder portion 281 in a slidable state, with the piston portion 282 being anchored to the frame upper portion 23.

It should be noted that a jack apparatus (not shown) is provided in the cylinder portion 281; by extending/retracting the jack apparatus, piston portion 282 can be extended upward relative to the cylinder portion 281, or can drop down due to its own weight.

Furthermore, extension arms 29 are provided between the support post 28 and the left and right frame side portions 22, respectively. These extension arms 29 are provided in the cylinder portion 281 of the support post 28, pivotally supported so that their base portions are rotatable central to the horizontal axis, and are configured of a tubular body 291 having a female screw, and an extension bolt 292 having a male screw that can be threaded into the female screw of the tubular body 291. The tips of the extension bolts 292 are connected to the frame side portions 22 so as to be rotatable, and the connecting portions of the extension bolts 292 are pivotally supported so as to be rotatable central to the horizontal axis relative to the frame side portions 22. Furthermore, manipulation portions 293, with which the extension bolts 292 are manipulated so as to rotate, are provided in the extension bolts 292.

For this reason, the extension bolts 292 can be extended/retracted relative to the tubular bodies 291 by manipulating the manipulation portions 293 and rotating the extension bolts 292, making it possible to extend or retract the frame side portions 22 through the extension/retraction of the extension bolts 292.

It should be noted that through-holes, through which lift/drop bolts 42 for movement devices 4 (described later) can be passed, are formed in the frame connectors 25 provided on the left and right ends of the frame lower portion 21, and nuts 271, into which the lift/drop bolts 42 can be threaded, are anchored opposite one another on the top and bottom surfaces of the through-holes.

The support member 3 is configured of: plural lower support portions 321 welded solid, at intervals in the left and right directions, to the outer surface of the three frame lower portions 21, which are in turn disposed at intervals in the front and rear directions; plural side support portions 341 welded solid, at intervals in the upper and lower directions, to the outer surface of the three left and right frame side portions 22, which are in turn disposed at intervals in the front and rear directions; and plural upper support portions 351 welded solid, at intervals in the left and right directions, to the outer surface of the three frame upper portions 23, which are in turn disposed at intervals in the front and rear directions. Square pipes are employed as the lower support portions 321, side support portions 341, and upper support portions 351.

The movement means 4 is configured of a bracket that pivotally supports a running wheel 41 so as to be rotatable, provided with a lift/drop bolt 42; the lift/drop bolt 42 is threaded into the nut 271 of the frame connector 25, as described earlier.

Hereinafter, operations of the support apparatus 1 according to this embodiment shall be described.

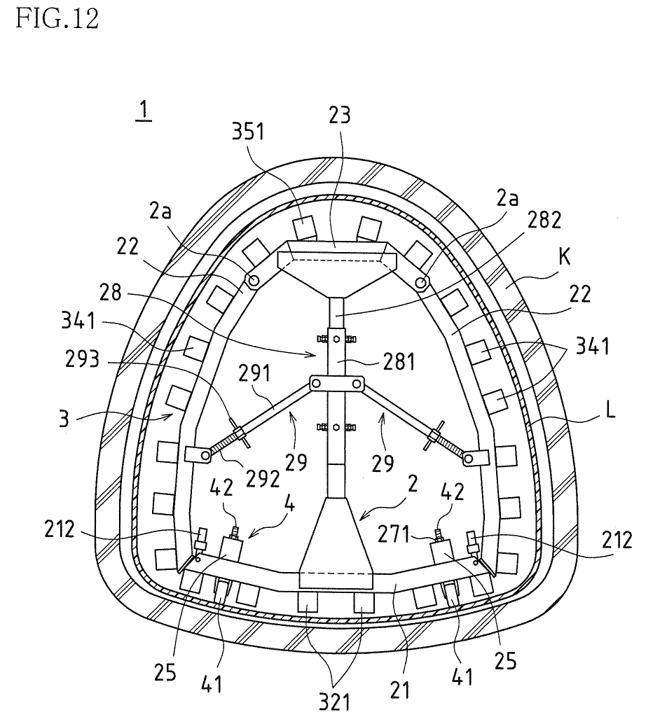

First, a lining pipe L is newly installed in an existing pipe K, after which the support apparatus 1, the support portions of which are in their retracted positions, is brought into the interior of the lining pipe L, and is transported to the section where packing of the back-filling material U is to be commenced (see FIG. 12).

Next, lift/drop bolts 42 are rotated relative to the frame lower portion 21, raising the running wheels 41, which causes the lower support portion 321 to drop, relatively speaking, and push against the inner surface of the lining pipe L. If the running wheels 41 have completely lifted off of the inner surface of the lining pipe L, the jack device (not shown) provided in the cylinder portion 281 of the support post 28 is extended, the piston portion 282 presses up relative to the cylinder portion 281, and the upper support portions 351 push against the inner surface of the lining pipe L. At this time, because the left and right frame side portions 22 are connected to the frame upper portion 23 via the hinges 2a, the left and right frame side portions 22, onto which the side support portions 34 are anchored, are also raised up in accordance with the frame upper portion 23.

After this, the manipulation portion 293 of the extension arm 29 is manipulated, rotating the extension bolt 292, which extends the extension bolt 292 relative to the tubular body 291; the frame side portions 22 rotate central to the hinges 2a and extend outwardly, and the side support portions 341 anchored to the frame side portions 22 push against the inner surface of the lining pipe L. At this time, the left and right frame side portions 22 elevate in accordance with the elevation of the frame upper portion 23, and within the cross-sectional horseshoe-shaped lining pipe L, the left and right frame side portions 22 are, due to this elevation, already moving into a position in the vicinity of the inner surface of the lining pipe L. Therefore, it is possible to reduce the amount of movement of the left and right frame side portions 22 caused by the manipulation of the extension arms 29 to the greatest extent possible, and to move the left and right frame side portions 22 into their supporting positions in a short amount of time.

If the side support portions 341 are pushing against the inner surface of the lining pipe L, the bearing members 212 provided in the frame lower portion 21 is rotated, and the turnbuckles are operated so that they make contact with the lower ends of the frame side portions 22, thereby supporting the frame side portions 22. In this manner, the frame lower portion 21, left and right frame side portions 22, and frame upper portion 23 form the frame body.

Although not illustrated in detail in the diagrams, next, injection holes are formed in the lining pipe L corresponding to injection openings formed in the left and right side support portions 341 and injection holes formed in the upper support portions 351, after which a pipe-shaped portion 51 of an injection nozzle attachment member 5 is inserted into the injection holes of the lining pipe L through the injection openings in the left and right side support portions 341 and the injection openings of the upper support portions 351. Meanwhile, pressure plates 6 are applied to the left and right side support portions 34 and upper support portion 35 over sealant 7, sandwiching the flange 52 of the injection nozzle attachment member 5 between themselves and the lining pipe L. After this, bolts b are passed through attachment holes 6a of the pressure plates 6, and are tightened down into the female screws 34b and 35b of the left and right side support portions 341 and the upper support portion 351, thereby anchoring the pressure plate 6.

If the injection nozzle attachment member 5 has been anchored over the pressure plate 6, an injection nozzle is coupled with the joint portion 61 of the pressure plate 6, and if back-filling material U is then supplied, the back-filling material U is packed into the space created between the outer surface of the lining pipe L, which is supported by the support apparatus 1, and the inner surface of the existing pipe K. At this time, a check valve 54 prevents the back-filling material U from experiencing backflow.

At this time, the packing pressure of the back-filling material U used in the lining pipe L can be supported by the plural frame lower portions 21, the plural left and right frame side portions 22, and the plural frame upper portions 23, of which the plural frame bodies 24 are configured, and to which are connected the plural lower support portions 321, the plural left and right side support portions 341, and the plural upper support portions 351, which push against the inner surface of the lining pipe L. In other words, an higher rigidity can be secured by connecting the plural frame bodies configured of the frame lower portions 21, the left and right frame side portions 22, and the frame upper portions 23, and accordingly, the packed pressure of the back-filling material U that acts on the support portions 321, 341, and 351 via the lining pipe L can be supported by this higher rigidity.

Once the packing of the back-filling material U has finished, the pressure plate 6 and sealant 7 are removed in order from the side support portions 341 and the upper support portions 351; after this, a cap is placed on the pipe-shaped portion 51 of the injection nozzle attachment member 5, closing off the opening of the pipe-shaped portion 51.

Once the back-filling material U has hardened, the support portions are returned to their retracted positions, and the support apparatus 1 is moved to the next section. To be more specific, the turnbuckles of the bearing members 212 provided in the frame lower portion 21 are operated, thereby being pulled away from the bottom ends of the frame side portions 22, which removes the support from the frame side portions 22; the bearing members 212 are rotated and stored in the frame lower portion 21. Next, the manipulation portion 293 of the extension arm 29 is manipulated, rotating the extension bolt 292, which retracts the extension bolt 292 relative to the tubular body 291, thus retracting the frame side portions 22 in an inward direction. Through this, the left and right frame side portions 22 rotate central to the hinges 2a between the frame side portions 22 and the frame upper portions 23, and thus the side support portions 341 retract from the inner surface of the lining pipe L. After this, the jack device provided in the cylinder portion 281 of the support post 28 is collapsed so that the piston portion 282 drops relative to the cylinder portion 281 and the upper support portions 351 retract from the inner surface of the lining pipe L, and the left and right frame side portions 22, connected to the frame upper portion 23 via the hinges 2a, drop. Next, the lift/drop bolts 42 are rotated relative to the frame lower portion 21, pushing the running wheels 41 down so as to rest upon the lining pipe L, whereby the lower support portions 321 lift, relatively speaking, and retract from the inner surface of the lining pipe L.

In this state, the lower support portions 321, side support portions 341, and upper support portions 351 of the support apparatus 1 retract from the inner surface of the lining pipe L, and because the running wheels 41 are at rest, the support apparatus 1 can be moved to the next section using the running wheels 41. Then, in the next section, the lower support portions 321, side support portions 341, and upper support portions 351 of each support apparatus 1 may be extended to their supporting positions so as to support the lining pipe L, the injection nozzle attachment member 5 may be attached, and the back-filling material U packed, in the manner described above.

It should be noted that, as mentioned earlier, yawing bar extending in the front direction may be provided in the front frame lower portion 21, and another yawing bar extending in the rear direction may be provided in the rear frame lower portion 21, plural support apparatuses 1 can be connected to one another by connecting the yawing bars in front and rear support apparatuses 1 and 1 via a connecting pin extending in the vertical direction. Through this, a support apparatus 1 in the rear can be rotated relative to a support apparatus 1 in the front, central to the connecting pin, so as to conform to curvatures in the lining pipe L.

In this case, although not illustrated in detail in the diagrams, when the lining pipe L curves in the left or right direction when viewed from above, the inner curvature radius of the curved portion of the lining pipe L is smaller, relatively speaking, than the outer curvature radius of the curved portion of the lining pipe L. Accordingly, side support portions 341 of a length corresponding to the inner curved portion of the lining pipe L, or in other words, of a relatively shorter size, may be connected to one of the left and right frame side portions 22 opposite the inner curved portion, whereas side support portions 341 of a length corresponding to the outer curved portion of the lining pipe L, or in other words, of a relatively longer size, may be connected to the other of the left and right frame side portions 22 opposite the outer curved portion, and the inner curved portion and outer curved portion of the lining pipe L may be supported in this manner. Similarly, when the lining pipe L curves in the up or down directions when viewed from the side, relatively short lower support portions 321 or upper support portions 351, corresponding to the inner curved portion of the lining pipe L, may be connected to the frame lower portion 21 or frame upper portion 23 opposite the inner curved portion, where the curvature radius is relatively smaller, whereas relatively long lower support portions 321 or upper support portions 351, corresponding to the outer curved portion of the lining pipe L, may be connected to the frame upper portion 23 or frame lower portion 21 opposite the outer curved portion, where the curvature radius is relatively larger, and the inner curved portion and outer curved portion of the lining pipe L may be supported in this manner. Therefore, when taking into consideration curvatures in the lining pipe L, it is necessary to use bolts or the like to connect support portions to frame portions in a manner that allows attachment/detachment, so that left and right side support portions 341 of differing lengths can be connected to/removed from the left and right frame side portions 22, respectively, as necessary, or so that lower support portions 321 and upper support portions 351 of differing lengths can be connected to/removed from the frame lower portion 21 and the frame upper portion 23, respectively, as necessary.

Here, it is preferable for the lower support portions 321, left and right side support portions 341, and upper support portions 351 of the support apparatus 1 to be between 0.5 m and 10 m, taking into account that the support apparatus 1 is moved by human power. In other words, in an environment in which water is present, a power source that utilized electricity is dangerous due to the possibility of electric shock, and thus cannot be used, meaning that the support apparatus is required to be moved my human power. In this case, as long as the support portions 321, 341, and 351 are within 10 m in length, it is possible to suppress the weight to within a range of the tractive force of the support apparatus 1 as determined by the product of the tractive force of a single worker and the number of workers.

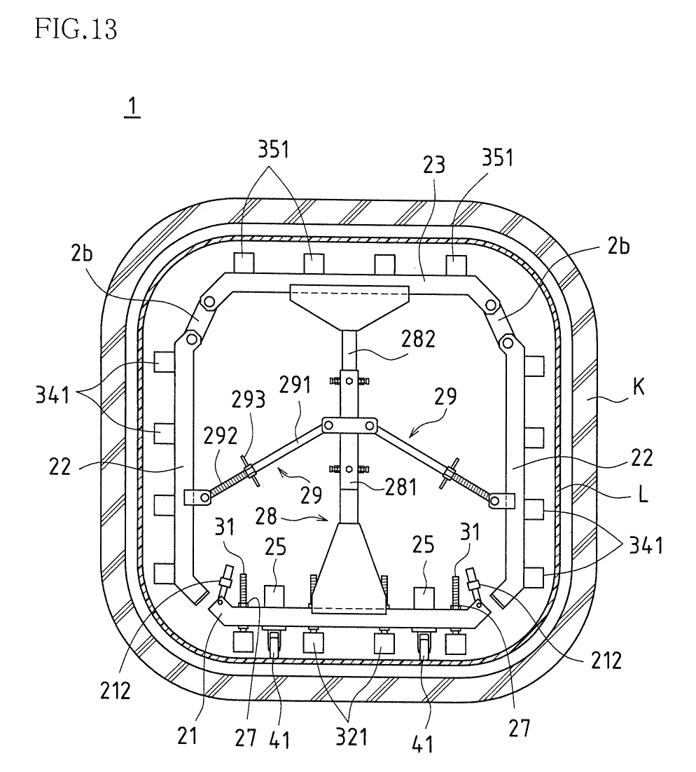

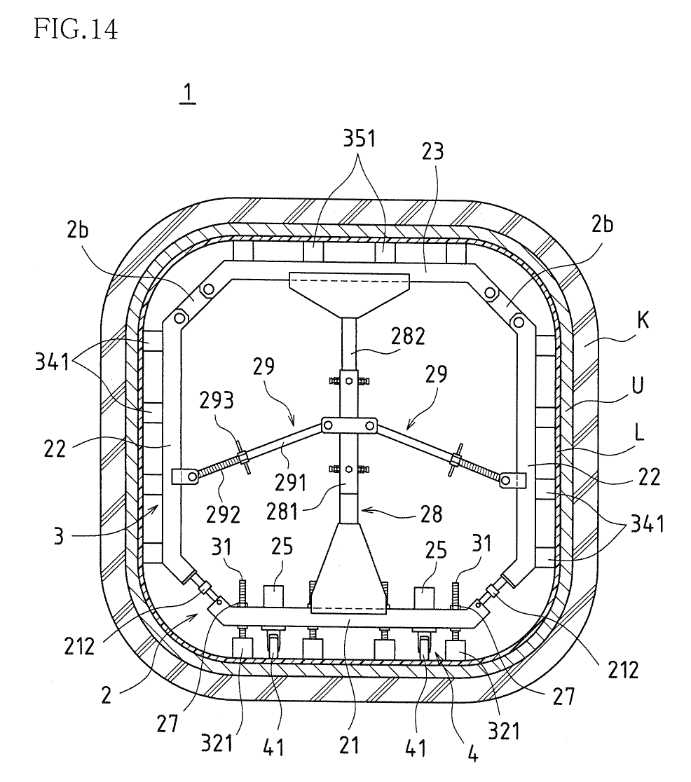

FIGS. 13 and 14 illustrate still another embodiment of the support apparatus 1 according to the present invention.

This support apparatus 1 has an almost identical configuration as the support apparatus 1 illustrated in FIGS. 10 to 12, and thus identical elements shall be given identical reference numerals, and detailed descriptions thereof shall be omitted. Only parts in which the configuration differs shall be described.

The frame 2 of this support apparatus 1 is configured of: a frame lower portion 21; a support post 28, the lower end of which is welded solid to the middle of the frame lower portion 21; a frame upper portion 23 welded solid to the upper end of the support post 28; left and right frame side portions 22 connected rotatably to the left and right ends of the frame upper portion 23 via links 2b; and frame connectors 25 provided between the left and right ends of plural frame lower portions 21 arranged at set intervals in the front and rear directions and between plural support posts 28. The frame lower portion 21, frame upper portion 23, and left and right frame side portions 22 are formed in a shape so as to conform to the respective sides of a lining pipe L, which has a cross-sectional square shape.

Through-holes, through which connection bolts 31 of a support member 3 can be passed, are formed in the left and right directions of the frame lower portion 21 at intervals, and nuts 27 into which the connection bolts 31 can be threaded are anchored opposed to one another on the top and bottom of the through-holes.

The support member 3 is configured of: plural connection bolts 31 threaded into the respective nuts 27 provided in the frame lower portions 21; lower support portions 321 connected to the connection bolts 31 so as to be rotatable; plural side support portions 341 welded solid, at intervals in the upper and lower directions, to the outer surface of the plural left and right frame side portions 22, which are in turn disposed at intervals in the front and rear directions; and plural upper support portions 351 welded solid, at intervals in the left and right directions, to the outer surface of the plural frame upper portions 23, which are in turn disposed at intervals in the front and rear directions. Square pipes are employed as the lower support portions 321, side support portions 341, and upper support portions 351.

Movement means 4 is running wheels 41 pivotally supported so as to be rotatable on brackets provided on the left and right ends of the frame lower portion 21.

Hereinafter, operations of the support apparatus 1 according to this embodiment shall be described.

First, a lining pipe L is newly installed in an existing pipe K, after which the support apparatus 1, the support portions of which are in their retracted positions, is brought into the interior of the lining pipe L, and is transported to the section where packing of the back-filling material U is to be commenced (see FIG. 13).

Next, connection bolts 31 are rotated relative to the frame lower portion 21, pushing the lower support portions 321 down and causing them to push against the inner surface of the lining pipe L. Furthermore, rotating the connection bolts 31 causes the frame lower portion 21, or in other words, the running wheels 41, to elevate, relatively speaking. If the running wheels 41 have completely lifted off of the inner surface of the lining pipe L, the jack device (not shown) provided in the cylinder portion 281 of the support post 28 is extended, the piston portion 282 presses up relative to the cylinder portion 281, and the upper support portions 351 push against the inner surface of the lining pipe L. At this time, because the left and right frame side portions 22 are connected to the frame upper portion 23 via the links 2b, the left and right frame side portions 22, onto which the side support portions 34 are anchored, are also raised up in accordance with the frame upper portion 23.

After this, the manipulation portion 293 of the extension arm 29 is manipulated, rotating the extension bolt 292, which extends the extension bolt 292 relative to the tubular body 291; the frame side portions 22 rotate central to the pivotal support portion of the links 2b and extend outwardly, and the side support portions 341 anchored to the frame side portions 22 push against the inner surface of the lining pipe L. At this time, the left and right ends of the frame upper portion 23 and the respective upper ends of the left and right frame side portions 22 are pivotally supported at the respective ends of the links 2b so as to be rotatable, and thus the left and right frame side portions 22 and frame upper portion 23 are positioned so as to conform to the top side and left and right sides of the cross-sectional square-shaped lining pipe L.

If the side support portions 341 are pushing against the inner surface of the lining pipe L, the bearing members 212 provided in the frame lower portion 21 are rotated, and the turnbuckles are operated so that they make contact with the bottom ends of the frame side portions 22, thereby supporting the frame side portions 22.

Although not illustrated in detail in the diagrams, next, injection holes are formed in the lining pipe L corresponding to injection openings formed in the left and right side support portions 341 and in the upper support portions 351, after which a pipe-shaped portion 51 of an injection nozzle attachment member 5 is inserted into the injection holes of the lining pipe L through the injection openings in the left and right side support portions 341 and the upper support portions 351. Meanwhile, pressure plates 6 are applied to the left and right side support portions 34 and upper support portion 35 over sealant 7, sandwiching the flange 52 of the injection nozzle attachment member 5 between themselves and the lining pipe L. After this, the pressure plates 6 are anchored to the left and right side support portions 341 and the upper support portions 351.

If the injection nozzle attachment member 5 has been anchored over the pressure plate 6, an injection nozzle is coupled with the joint portion 61 of the pressure plate 6, and if back-filling material U is then supplied, the back-filling material U is packed into the space created between the outer surface of the lining pipe L, which is supported by the support apparatus 1, and the inner surface of the existing pipe K, while backflow of the back-filling material U is prevented by the check valve 54.

Once the packing of the back-filling material U has finished, the pressure plate 6 and sealant 7 are removed from the side support portions 341 and the upper support portions 351; after this, a cap (not shown) is placed on the pipe-shaped portion 51 of the injection nozzle attachment member 5, closing off the opening of the pipe-shaped portion 51.

After this, once the back-filling material U has hardened, turnbuckles of the bearing members 212 provided in the frame lower portion 21 are operated, thereby being pulled away from the bottom ends of the frame side portions 22, which removes the support from the frame side portions 22; the bearing members 212 are rotated and stored in the frame lower portion 21. Next, the manipulation portion 293 of the extension arm 29 is manipulated, rotating the extension bolt 292, which retracts the extension bolt 292 relative to the tubular body 291; the frame side portions 22 rotate central to the pivotal support portion of the links 2b and retract inwardly, and the side support portions 341 pull away from the inner surface of the lining pipe L. After this, the jack device provided in the cylinder portion 281 of the support post 28 is collapsed so that the piston portion 282 drops relative to the cylinder portion 281 and the upper support portions 351 retract from the inner surface of the lining pipe L, and the left and right frame side portions 22, connected to the frame upper portion 23 via the links 2b, drop. Next, the connection bolts 31 are rotated relative to the frame lower portion 21, raising the lower support portion 321, which causes the lower support portion 321 to rise off of the inner surface of the lining pipe L, and also causes the running wheels 41 to rest upon the inner surface of the lining pipe L.

Here, the lower support portions 321, side support portions 341, and upper support portions 351 of the support apparatus 1 retract from the inner surface of the lining pipe L, and because the running wheels 41 are at rest, the support apparatus 1 can be moved to the next section using the running wheels 41. Then, in the next section, the lower support portions 321, side support portions 341, and upper support portions 351 of each support apparatus 1 may be extended to their supporting positions so as to support the lining pipe L, the injection nozzle attachment member 5 may be attached, and the back-filling material U packed, in the manner described above.

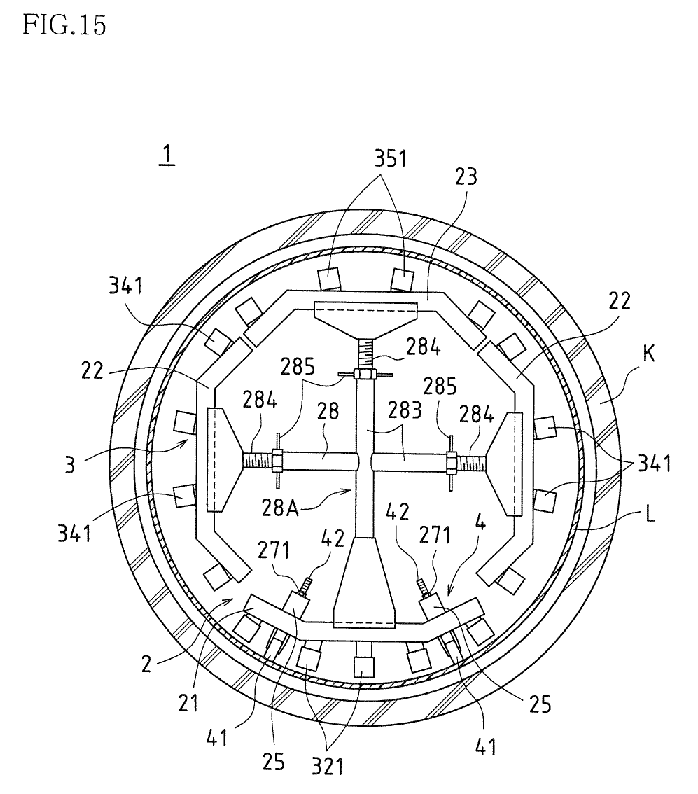

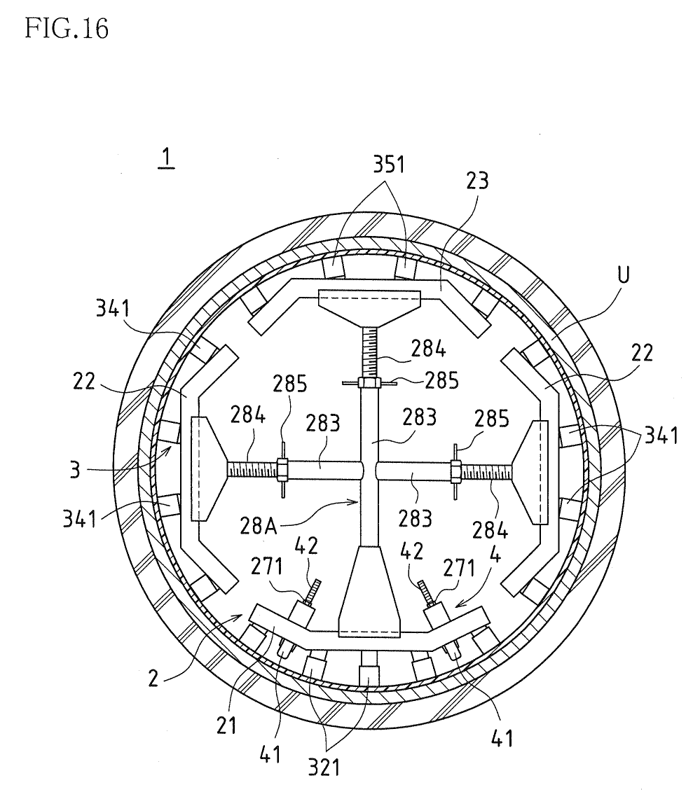

FIGS. 15 and 16 illustrate yet another embodiment of the support apparatus 1 according to the present invention.

This support apparatus 1 also has an almost identical configuration as the support apparatus 1 illustrated in FIGS. 10 to 12, and thus identical elements shall be given identical reference numerals, and detailed descriptions thereof shall be omitted. Only parts in which the configuration differs shall be described.

The frame 2 of this support apparatus 1 is configured of: a frame lower portion 21; a cross-shaped support post 28A, the lower end of which is welded solid to the middle of the frame lower portion 21; a frame upper portion 23 rotatably connected to the upper end of the support post 28A; left and right frame side portions 22 connected rotatably to the left and right ends of the support post 28A; and frame connectors 25 provided between the left and right ends of plural frame lower portions 21 arranged at set intervals in the front and rear directions and between plural support posts 28A. The frame lower portion 21, frame upper portion 23, and left and right frame side portions 22 are formed so as to form the sides of an almost octagonal shape, so as to conform to a lining pipe L, which has a cross-sectional circular shape.

Here, the support post 28A is welded solid in a cross shape, and is configured of: tubular bodies 283, each of which has a female screw; extension bolts 284 that have male screws that can be threaded into the female screws of the tubular bodies 283; and manipulation portions 285 provided as part of each extension bolt 284, via which the extension bolts 284 can be rotated. The tips of the respective extension bolts 284 are connected so as to be rotatable relative to the frame upper portion 23 and the left and right frame side portions 22.

Next, descriptions shall be given regarding operations of this support apparatus 1. First, a lining pipe L is newly installed in an existing pipe K, after which the support apparatus 1, the support portions of which are in their retracted positions, is brought into the interior of the lining pipe L, and is transported to the section where packing of the back-filling material U is to be commenced (see FIG. 15).

Next, lift/drop bolts 42 are rotated relative to the frame lower portion 21 in each support apparatus 1, raising the running wheels 41, which causes the lower support portion 321 to drop, relatively speaking, and rest upon the inner surface of the lining pipe L. If the running wheels 41 have completely lifted off of the inner surface of the lining pipe L, each of the extension bolts 284 of the support post 28A are rotated via the manipulation portions 284, thereby extending the extension bolts 284 relative to their respective tubular bodies 283. For this reason, the frame upper portion 23 elevates, and the upper support portions 351 push against the inner surface of the lining pipe L. Furthermore, the left and right frame side portions 22 extend in the outward direction, and the side support portions 341 push against the inner surface of the lining pipe L.

If the lower support portions 321, side support portions 341, and upper support portions 351 are pushing against the inner surface of the lining pipe L, as described earlier, injection holes are formed in the lining pipe L, after which an injection nozzle attachment member 6 is inserted into the injection holes of the lining pipe L. Furthermore, pressure plates 6 are anchored to the left and right side support portions 341 and upper support portion 351 over sealant 7, anchoring the injection nozzle attachment member 5. After this, an injection nozzle is coupled with a joint portion 61 of the pressure plate 6, and back-filling material U is supplied.

Once the packing of the back-filling material U has finished, the pressure plate 6 and sealant 7 are removed from the side support portions 341 and the upper support portions 351; after this, a cap (not shown) is placed on the pipe-shaped portion 51 of the injection nozzle attachment member 5, closing off the opening of the pipe-shaped portion 51.

If the back-filling material U has hardened, the extension bolts 284 of the support post 28A are rotated using the manipulation portions 285, retracting the extension bolts 284 relative to their respective tubular bodies 283. For this reason, the frame upper portion 23 drops, and the upper support portions 351 retract from the inner surface of the lining pipe L. Furthermore, the left and right frame side portions 22 retract inward, and the side support portions 341 retract from the inner surface of the lining pipe L.

Next, the lift/drop bolts 42 are rotated relative to the frame lower portion 21, pushing the running wheels 41 down so as to rest upon the lining pipe L, whereby the lower support portions 321 lift, relatively speaking, and retract from the inner surface of the lining pipe L.

In this state, as shown in FIG. 15, the lower support portions 321, side support portions 341, and upper support portions 351 retract from the inner surface of the lining pipe L, and because the running wheels 41 are at rest, the support apparatus 1 can be moved to the next section using the running wheels 41. Then, in the next section, the lower support portions 321, side support portions 341, and upper support portions 351 of each support apparatus 1 may be extended to their supporting positions so as to support the lining pipe L, the injection nozzle attachment member 5 may be attached, and the back-filling material U packed, in the manner described above.

### INDUSTRIAL APPLICABILITY

As described thus far, according to the present invention, when restoring an existing pipe using a lining pipe, the support apparatus can be moved to the next section in which back-filling material is to be packed without requiring the support apparatus to be assembled and disassembled, which improves operational efficiency and shortens the construction period.

1. A support apparatus that supports a lining pipe when packing back-filling material between the inner surface of an existing pipe and the outer surface of the lining pipe, the lining pipe having been newly installed within the existing pipe, the support apparatus comprising:
a frame; and
a support member and a movement means provided in the frame,
wherein the support member includes support portions that can be freely moved between a supporting position in which the support portions make contact with and support the inner surface of the lining pipe and a retracted position in which the support portions are retracted from the inner surface of the lining pipe;
and the movement means, which is anchored to the frame, rests upon and is capable of traveling on the inner surface of the lining pipe when the support portions are in the retracted position.

2. A support apparatus that supports a lining pipe when packing back-filling material between the inner surface of an existing pipe and the outer surface of the lining pipe, the lining pipe having been newly installed within the existing pipe, the support apparatus comprising:
a frame; and
a support member and movement means provided in the frame,
wherein the support member includes support portions that can be freely moved between a supporting position in which the support portions make contact with and support the inner surface of the lining pipe and a retracted position in which the support portions are retracted from the inner surface of the lining pipe;
and the movement means can be lifted and dropped freely between a traveling position in which the movement means rests upon the inner surface of the lining pipe and a retracted position in which the movement means is retracted from the inner surface of the lining pipe.

3. The support apparatus according to claim 1 or 2,
wherein the support portions are provided with a pressure plate that can be freely attached/detached, and an injection nozzle attachment member, inserted into an injection hole formed in the lining pipe, is anchored by the pressure plate.

4. The support apparatus according to claim 2,
wherein the frame is configured of a frame lower portion, a frame upper portion connected to the frame lower portion via a support post that is freely liftable and droppable, and frame side portions connected to the left and right ends of the frame upper portion so as to be freely rotatable and connected to the support post via a freely extendable and retractable extension arm; and
the support portions are configured of plural lower support portions connected to the frame lower portion, plural upper support portions connected to the frame upper portion, and plural side support portions connected to the left and right frame side portions, respectively.

5. The support apparatus according to claim 2,
wherein the frame is configured of plural frame lower portions connected at intervals in the front and rear directions by frame connectors, plural frame upper portions connected respectively to the frame lower portions via support posts that are freely liftable and droppable, and plural left and right frame side portions, each of which is connected to the left and right ends of respective frame upper portions so as to be freely rotatable and connected to respective support posts via freely extendable and retractable extension arms; and
the support portions are configured of plural lower support portions connected across the plural frame lower portions, plural upper support portions connected across the frame upper portions, and plural side support portions connected across the left and right frame side portions.

6. The support apparatus according to claim 4 or 5,
wherein the lower support portions, the upper support portions, and the side support portions are formed so as to be of lengths corresponding to a curvature in the lining pipe, and are connected to the frame lower portions, the frame upper portions, and the left and right frame side portions, respectively, that face the curvature, so as to be freely attachable and detachable.

7. The support apparatus according to claim 4 or 5,
wherein bearing members that make contact with and are capable of supporting the left and right frame side portions are provided on the left and right ends of the frame lower portions.

8. The support apparatus according to claim 4 or 5,
wherein the lower support portions, upper support portions, and side support portions are 0.5 m to 10 m in length.
